(19) United States
(12) Patent Application Publication
(10) Pub. No.: US 2003/0014487 A1
(43) Pub. Date: Jan. 16, 2003

(54) Introduction system

(75) Inventors: Akinori Iwakawa, Kawasaki (JP); Satoshi Okuyama, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/995,815

(22) Filed: Nov. 29, 2001

(30) Foreign Application Priority Data
Jul. 16, 2001 (JP) 2001-215759

(51) Int. Cl. G06F 15/16; G09G 5/00

(52) U.S. Cl. 709/204; 345/753

(57) ABSTRACT

An “introducing” information generating part of an introducing part generates “introducing” information based on data in a buddy list storing part, in accordance with an instruction of a user of the introduction origin system, and notifies an introduction destination system of the “introducing” information through an “introducing” information notifying part. A buddy list registering part of the introduction system registers a user to a buddy list based on the “introducing” information and generates registration information. A registration information notifying part notifies the introduction target system of the registration information. Furthermore, the registration information notifying part notifies the introduction target system of “introduced” information representing that introduction is received. An “introduced” recognizing part of the introduction target system recognizes an introduction relationship. Furthermore, a state information notifying part notifies an introduction destination system of state information based on the registration information.

### BACKGROUND OF THE INVENTION

1. Field of the Invention

The present invention relates to an introduction system for allowing an introduction origin system to introduce an introduction target system to an introduction destination system through an on-line network system.

2. Description of the Related Art

With the widespread use of the Internet, communications are being actively conducted through an on-line network system. In order to conduct smooth communications, a system using a user list, in particular, a buddy list system is being used on a worldwide basis. A buddy list system is used for supporting communications with a partner side system, displaying the state of a partner side system, and the like.

In the case where a buddy list system is used for supporting communications with a partner side system, user entry information on a partner side system with which communications are conducted often is previously registered on a list called a buddy list, and user entry information on a partner side system is selected from the buddy list when communications are conducted, whereby a partner side system can easily be specified. The current buddy list system is generally used in instant message delivery service for delivering a simple message, and the like. There is no particular limit to the communication means of the delivery service, and various means such as a telephone and electronic mail can be used.

In the case where the buddy list system is used for displaying the state of a partner side system, if user entry information on a partner side system from which a state display is desired to be obtained is previously registered to a buddy list, state information is displayed in a predetermined region on a computer display screen, which represents the state of a registered partner side system at all times or at a predetermined timing. Thus, the state of a partner side system can be displayed, which represents whether or not the partner side system is in operation, whether or not an event has occurred in the partner side system, and the like. Furthermore, by synchronizing the buddy list system with an entry/exit system, the state representing whether or not a user of a partner side system is in meeting or on the business trip can be displayed.

FIG. 23 is a view showing a conventional configuration of a buddy list system configured between users A and B. In FIG. 23, reference numeral 500 denotes a system used by the user A, 501 denotes a buddy list registering part, 502 denotes a buddy list storing part, 503 denotes a registration information notifying part, 504 denotes a state information receiving part, and 505 denotes a state information display part. Furthermore, reference numeral 510 denotes a system used by the user B, 511 denotes a registration information receiving part, 512 denotes a state information generating part, and 513 denotes a state information notifying part.

A flow of a basic operation of the above-mentioned buddy list system is as follows. First, the user A specifies and inputs user entry information of the user B with respect to the buddy list registering part 501. The buddy list registering part 501 registers a user to a buddy list in the buddy list storing part 502. The registration information notifying part 503 notifies a user system 510 of the user B of registration information containing identifier information of a user system 500. The user system 510 receives the registration information at the registration information receiving part 511. Herein, the user system 510 has a function of notifying the user system 500 of its own state at a predetermined timing or in the case where there is a change in its state information. More specifically, the state information notifying part 513 sends state information generated by the state information generating part 512 to the user system 500, based on the identifier information of the user system 500 contained in the registration information. The user system 500 of the user A receives the state information at the state information receiving part 504, and displays the state information by the state information display part 505. In the above description, the state information is sent from a system registered to the buddy list to a registering system, using a so-called “push” technique. However, the state information may be sent from a registering system to a registered system, using a so-called “pull” technique.

As described above, in the buddy list system, a user who desires to register a system of another user to a buddy list specifies a partner to be registered by using an identifier assigned to each user system. The buddy list system generally has a function of detecting an actual position of a user system on a network from its identifier by using known means such as a domain name system (DNS), and sending/receiving required information to the detected user system, and a user system on a registering side automatically obtains state information of a user system on a registered side.

The buddy list system as described above is important to a service provider conducting commercial activities. More specifically, if user entry information on a service provider is registered to a buddy list in a user system, the state regarding the provision of service can be displayed on a customer system, which is useful for presentation. Furthermore, due to the communication support function of the buddy list system, when a user desires to use service, a service provider becomes more likely to allow the user to use its service. As a result, the service provider has the advantage over the other providers.

The above-mentioned buddy list system is considered to be an important technique to a service provider in terms of sales strategy. More specifically, if a service provider has its user entry information registered to a buddy list in a user system, its advertising information and the like can be provided as a state display using the buddy list, and communications with a user become active. As a result, the service provider has the advantage over the other providers. Herein, there is a problem of how a service provider has its user entry information registered to a buddy list in a user system.

JP 2000-364371 A discloses an effective technique of giving a user an incentive to register user entry information of a service provider to a buddy list of a user. According to this technique, a user registers user entry information on a service provider to a buddy list and notifies the service provider of the registration, whereby the service provider notified of the registration issues coupons regarding the provision of service to the user. Issuance of coupons attracts users, so that registration of the service provider to a buddy list can be expected to some degree.

However, according to the technique of JP 2000-364371 A, it is required that a user finds a service provider that actively issues coupons, obtains user entry information on the service provider, registers the user entry information on the service provider to a buddy list, and notifies the service provider of the registration of the user entry information. If such time and labor involved in these operations can be reduced, the registration to a buddy list is expected to be promoted.

Furthermore, although issuance of coupons is attractive to a user, a user is not sure about whether or not the service provider issuing coupons is reliable, and the quality of service provided by the service provider is good. Therefore, a user hesitates to register all the service providers issuing coupons to a buddy list. If this psychological anxiety can be reduced, the registration to a buddy list is expected to be promoted.

In general commercial activities, a goods sales promoting method and a service use promoting method are known, in which when a service user introduces another user to a service provider, the service provider gives an incentive (e.g., payback) to an introducing user or an introduced user. According to this method, the introduced user can confirm the reliability of the service provider and the excellence of the quality of service provided by the service provider through the introducing user. Therefore, smooth sales of goods and provision of service, combined with personal reliability of the introducing user, are promoted.

However, the above-mentioned goods sales promotion method and service use promotion method have the following drawbacks. Generally, an incentive is given based on introduction when an introduced user determines to use service or when at least planned use of service is confirmed. Therefore, psychological pressure for the introduced user to use service is high, and if the desire of the introduced user for use of service is not high enough, the incentive providing method is unlikely to be used.

In order to overcome the above-mentioned problem, the following may also be possible: at a time of introduction, sales of goods and provision of service are not conducted immediately, and an incentive is given when a user actually utilizes service later. However, according to this method, there is a strong possibility that, with the passage of time after introduction, the impression of an introduced user with respect to introduced service may become weak, and the introduced user may forget user entry information for accessing a service provider. In order to call attention of a user, it is also possible to regularly send direct mail. However, some users may have a bad impression on such direct mail, which may have the opposite effect.

### SUMMARY OF THE INVENTION

Therefore, with the foregoing in mind, it is an object of the present invention to support the registration of a user on a user list. In particular, it is an object of the present invention to reduce time and labor involved in registration of a service provider into a buddy list system, enhance reliability of the service provider through introduction of another user, and promote the registration of a service provider to a buddy list system.

In order to achieve the above-mentioned object, the introduction system of the present invention allows an introduction origin system to introduce an introduction target system to an introduction destination system through an on-line network system, wherein the introduction origin system includes an introducing part for notifying the introduction destination system of “introducing” information containing user entry information of the introduction target system, the introduction destination system includes a registering part for receiving the “introducing” information notified from the introducing part of the introduction origin system and registering user entry information of the introduction target system on a user list, and an “introduced” information notifying part for detecting registration of the user entry information of the introduction target system on the user list in the registering part and notifying the introduction target system of “introduced” information representing that a registration action based on introduction has been conducted, and the introduction target system includes an “introduced” recognizing part for receiving “introduced” information from the “introduced” information notifying part of the introduction destination system and recognizing a registration action to the user list in the introduction destination system.

Because of the above-mentioned configuration, the introduction target system can recognize that an “introducing” action from the introduction origin system to the introduction destination system and a registration action to a user list have been conducted.

It is preferable that the user list is a buddy list, and a buddy list system is configured between the introduction destination system and the introduction target system, based on registration of a user entry of the introduction target system to the buddy list of the introduction destination system, the introduction target system notifies the introduction destination system of state information representing a state of the introduction target system through a network, and the introduction destination system obtains the state information of the introduction target system through the network and refers to it.

Because of the above-mentioned configuration, the introduction system of the present invention can be applied to a buddy list system.

Herein, the state information refers to information representing the state of a partner side system or a user, for example, information represented by an icon or a message. The state of a partner side system and the state of a user representing that the user is on the business trip or the like can be grasped by referring to the state information.

It is preferable that, in the above-mentioned introduction origin system, the introducing part has a function of notifying the introduction target system that an “introducing” action has been conducted, and the introduction target system further includes an “introducing” recognizing part for receiving “introducing” information notified from the introducing part of the introduction origin system and recognizing the “introducing” action in the introduction origin system based on the “introducing” information, and an “introduction” confirming part for comparing contents recognized by the “introduced” recognizing part with contents recognized by the “introducing” recognizing part, and confirming an introduction relationship between the introduction origin system and the introduction destination system.

Because of the above-mentioned configuration, the introduction target system receives so-called self-declaration of an “introducing” action from the introduction origin system, and compares the contents of the “introducing” action with the contents of a registration action notified from the introduction destination system, thereby confirming the “introducing” action.

It is preferable that, in order to provide an incentive, the introduction target system is a service provider, and the introduction target system includes an incentive providing part for giving an incentive to change conditions for providing service with respect to either one or both of the introduction origin system and the introduction destination system, in a case where the “introduced” recognizing part recognizes an introduction relationship between the introduction origin system and the introduction destination system.

It is preferable that, in order to provide an incentive, the introduction target system is a service provider, and the introduction target system includes an incentive providing part for giving an incentive to change conditions for providing service with respect to either one or both of the introduction origin system and the introduction destination system, in a case where the “introduction” confirming part confirms an introduction relationship between the introduction origin system and the introduction destination system.

Because of the above-mentioned configuration, an incentive can be given to an introduction origin system or an introduction destination system in which an “introducing” action and a registration action have been recognized and confirmed, whereby registration to a buddy list of the introduction target system can be promoted.

It is also preferable that the introduction target system includes an incentive notifying part for notifying the introduction origin system or the introduction destination system of contents of an incentive given by the incentive providing part based on a past “introducing” action and registration action or contents of an incentive to be provided by the incentive providing part based a future introduction relationship.

This is because it is possible to grasp to which degree an incentive is currently given or to which degree an incentive will be given if an “introducing” action and a registration action is conducted, whereby an “introducing” action and a registration action can be promoted.

It is preferable that, in a registering part of the introduction destination system, in a case where the entry information of the introduction target system is deleted from the user list or the introduction destination system is not used by a user any more, the introduction relationship between the introduction origin system and the introduction target system is cancelled.

This is because the introduction relationship can be considered to be cancelled.

These and other advantages of the present invention will become apparent to those skilled in the art upon reading and understanding the following detailed description with reference to the accompanying figures.

### BRIEF DESCRIPTION OF THE DRAWINGS

FIG. 1 is a view showing a schematic configuration of an introduction system of Embodiment 1 according to the present invention.

FIG. 2 is a view showing an example of “introducing” information generated in an introduction origin system.

FIG. 3 is a view showing an example of “introduced” information generated in an introduction destination system.

FIG. 4 is a view showing an example of “introduced” recognition information generated in an introduction target system.

FIG. 5 is a view showing an exemplary configuration of an exchange server.

FIG. 6 is a flow chart showing “introducing” processing in an introduction origin system.

FIG. 7 is a flow chart showing registration processing in an introduction destination system.

FIG. 8 is a flow chart showing registration recognition processing in an introduction target system.

FIG. 9 is a view showing an example of a display screen of a buddy list.

FIG. 10 is a view illustrating an “introducing” operation using a buddy list.

FIG. 11 is a view showing an example of a selection screen for whether or not “introducing” information is registered.

FIG. 12 is a view showing a schematic configuration of an introduction system of Embodiment 2 according to the present invention.

FIG. 13 is a view showing an example of “introducing” information generated in an introduction origin system.

FIG. 14 is a flow chart showing “introducing” processing in an introduction origin system.

FIG. 15 is a flow chart showing registration recognition processing and registration confirmation processing in an introduction target system.

FIG. 16 is a view showing a schematic configuration of an introduction system of Embodiment 3 according to the present invention.

FIG. 17 is a view showing another schematic configuration of the introduction system of Embodiment 3 according to the present invention.

FIG. 18 is a view showing a configuration in the case of presenting the contents of an incentive in Embodiment 3 according to the present invention.

FIG. 19 is a view showing a schematic configuration of an introduction system of Embodiment 4 according to the present invention.

FIG. 20 shows update processing of an introduction relationship by an “introduction” confirming part.

FIG. 21 shows update confirmation processing of an introduction relationship by an “introduction” confirming part.

FIG. 22 shows examples of a recording medium storing a processing program for realizing an introduction system of Embodiment 5 according to the present invention.

FIG. 23 is a view showing a configuration of a conventional buddy list system.

### DESCRIPTION OF THE PREFERRED EMBODIMENTS

An introduction system of the present invention will be described by way of embodiments. In the following description of the embodiments of the introduction system according to the present invention, a buddy list is used as a user list, and a buddy list system is configured between an introduction destination system and an introduction target system.

“Introducing” information refers to information for an introduction origin system to notify an introduction destination system or an introduction target system of the contents of an “introducing” action, when the “introducing” action is conducted. The “introducing” information contains information specifying an introduction origin system and an introduction destination system or an introduction target system.

“Introduced” information refers to information for an introduction destination system to notify an introduction target system that the introduction destination system has received introduction, when receiving “introducing” information from the introduction origin system. The “introduced” information contains information specifying an introduction origin system, an introduction destination system, and an introduction target system.

### EMBODIMENT 1

In an introduction system of Embodiment 1 according to the present invention, an introduction origin system introduces an introduction target system to an introduction destination system through an on-line network system. Introduction may be conducted on the basis of service provided by the introduction target system. Introduction is conducted in such a manner that user entry information of the introduction target system is registered on a user list of the introduction destination system. For example, an identifier is assigned to service of the introduction target system, and the introduction origin system notifies the introduction destination system of user entry information containing identifier information of the introduction target system, and the user entry information is registered as a user on a user list of the introduction destination system.

In a buddy list system described in the present embodiment, the introduction destination system sends registration information containing its identifier information to the introduction target system when adding a new user entry to its buddy list. Furthermore, state information of the introduction target system is sent to the introduction destination system by a “push” technology from the introduction target system to the introduction destination system. The introduction system of the present embodiment is also applicable even if the introduction destination system does not send its identifier information to the introduction target system when adding a new user entry to the buddy list of the introduction destination system, and state information of the introduction target system is sent to the introduction destination system by a “pull” technology from the introduction destination system to the introduction target system.

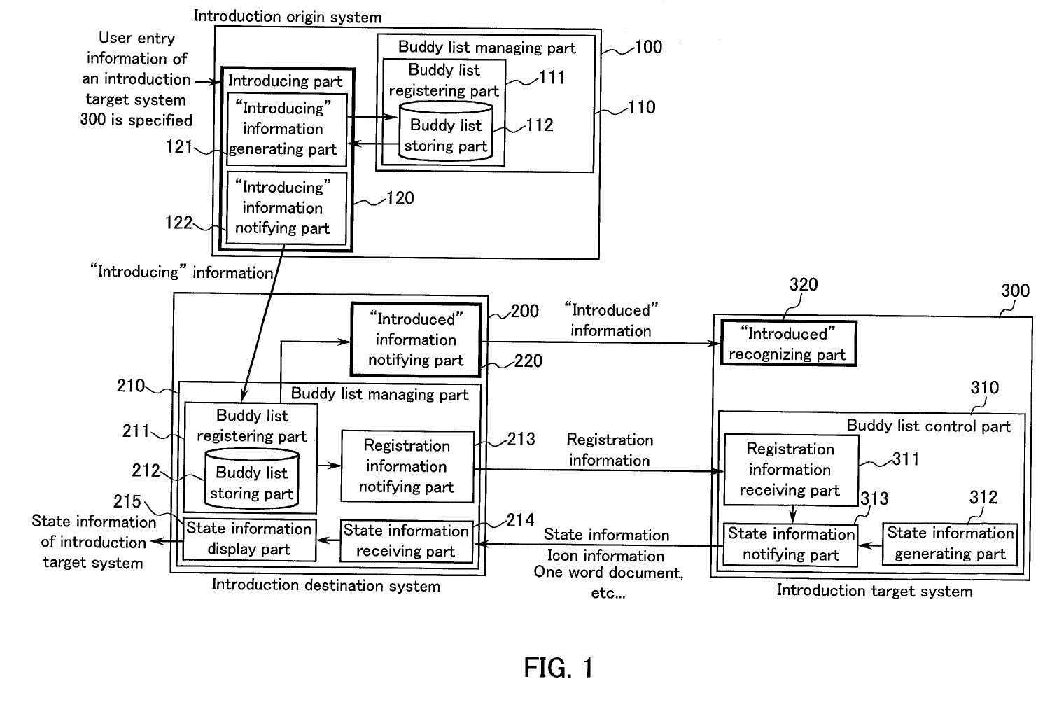

FIG. 1 is a view showing a schematic configuration of the introduction system of Embodiment 1 according to the present invention.

Reference numeral 100 denotes an introduction origin system, 200 denotes an introduction destination system, and 300 denotes an introduction target system. Herein, it is assumed that an identifier is assigned to each system, and an identifier of the introduction origin system 100 is “A”, an identifier of the introduction destination system 200 is “B”, and an identifier of the introduction target system 300 is “C”.

The introduction origin system 100 includes a buddy list managing part 110 and an introducing part 120.

The buddy list managing part 110 stores and manages a buddy list of the introduction origin system 100. Although not shown in FIG. 1, in order to display state information using the buddy list and the like, the introduction origin system 100 may also have the same configuration as that of a buddy list managing part 210 of the introduction destination system 200.

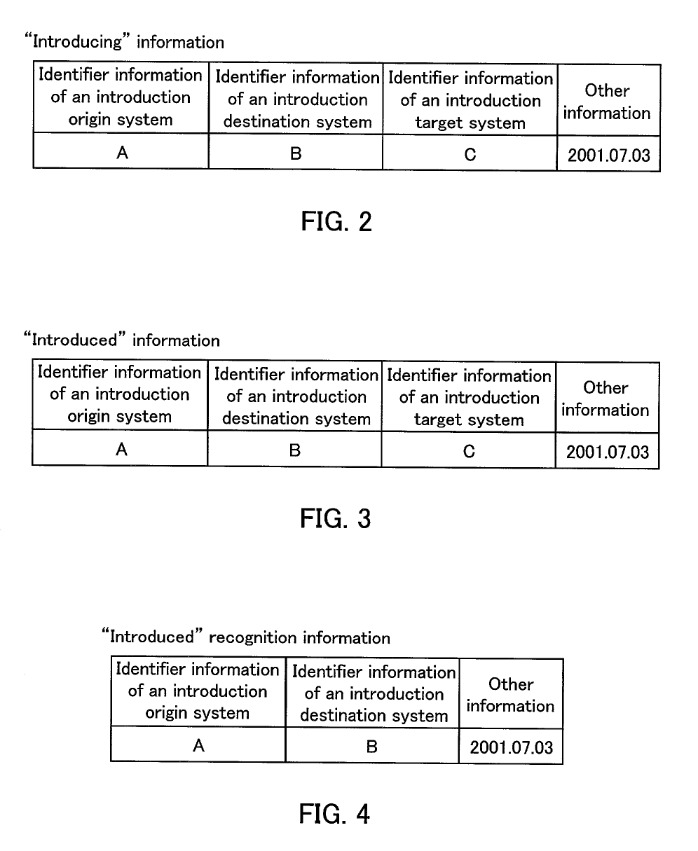

The introducing part 120 includes an “introducing” information generating part 121 and an “introducing” information notifying part 122. Upon detecting an operation instruction of introducing a user (introduction target system 300) to another user (introduction destination system 200) on the buddy list in an operation by a user A of the introduction origin system 100, the “introducing” information generating part 121 extracts user entry information that becomes an introduction target from the buddy list managing part 110 and generates “introducing” information. The “introducing” information to be generated is, for example, as shown in FIG. 2. This example includes items such as identifier information of an introduction origin system, identifier information of an introduction destination system, identifier information of an introduction target system, and other information. In this example, the respective items are provided with item values “A”, “B”, “C”, and “introduction date and time”.

The introducing part 120 notifies the introduction destination system 200 of the generated “introducing” information through the “introducing” information notifying part 122.

The introduction destination system 200 includes a buddy list managing part 210 and an “introduced” information notifying part 220.

The buddy list managing part 210 includes a buddy list registering part 211 and a buddy list storing part 212, and stores and manages the buddy list of the introduction destination system 200. The buddy list managing part 210 also includes a registration information notifying part 213, and sends registration information containing its identifier information to the introduction target system 300 that is a partner side system, when new user entry information is added to the buddy list. The buddy list managing part 210 also includes a state information receiving part 214 and a state information display part 215, and upon being notified of state information from the introduction target system 300, the buddy list managing part 210 displays the state of the introduction target system 300 based on the state information, as described later.

The buddy list managing part 210 may also have a communication support function with respect to a system registered to the buddy list. In the case where a user of the introduction destination system 200 desires to communicate with the introduction target system 300, the buddy list managing part 210 supports formation of a communication path to the introduction target system 300 by selecting a user entry of the introduction target system 300 displayed on the buddy list.

The buddy list registering part 211 receives “introducing” information notified from the introducing part 120 of the introduction origin system 100. Although not shown in FIG. 1, the buddy list registering part 211 may include a registration selection function. The purpose of this is to give discretion in selecting whether or not an entry of an introduced user is registered to the buddy list. The registration selection function has a function of presenting a selection dialog for asking whether or not a user introduced to a user B is registered and a function of accepting the selection instruction. In the case where the user B selects registration, user entry information of the introduction target system is extracted from the received “introducing” information, and registered to the buddy list of the buddy list storing part 212. As a result, the introduction target system 300is registered to the buddy list of the introduction destination system as a user. When the registration of the user entry information of the introduction target system 300 to the buddy list is completed, the buddy list registering part 211 notifies the “introduced” information notifying part 220 of the completion of the registration.

Upon being notified of the completion of the registration of the user entry information of the introduction target system 300 to the buddy list from the buddy list registering part 211, the “introduced” information notifying part 220 generates “introduced” information. The “introduced” information is, for example, as shown in FIG. 3. This example includes four items: identifier information of an introduction origin system, identifier information of an introduction destination system, identifier information of an introduction target system, and other information. In this example, the respective items are provided with item values “A”, “B”, “C”, and “introduction date and time”. Although the items in this example are the same as those of the “introducing” information shown in FIG. 2, they are not necessarily required to be the same. The “introduced” information notifying part 220 notifies the introduction target system 300 of the generated “introduced” information.

The introduction target system 300 includes a buddy list control part 310 and an “introduced” recognizing part 320.

The buddy list control part 310 includes a registration information receiving part 311, which receives registration information notified from the introduction destination system 200 and extracts identifier information “B” of the introduction destination system 200. Furthermore, the buddy list control part 310 includes a state information generating part 312 and a state information notifying part 313. The state information generating part 312 generates state information, and the state information notifying part 313 sends the state information to the introduction destination system 200 based on the identifier “B” of the introduction destination system 200.

The “introduced” recognizing part 320 receives “introduced” information notified from the “introduced” information notifying part 220 of the introduction destination system 200, and generates “introduced” recognition information from the received “introduced” information. The “introduced” recognition information to be generated is, for example, as shown in FIG. 4. This example includes three items: identifier information of an introduction origin system, identifier information of an introduction destination system, and other information. The respective items are provided with item values “A”, “B”, and “introduction date and time”.

The “introduced” recognizing part 320 stores the generated “introduced” recognition information.

Thus, the introduction origin system 100 introduces the introduction target system 300 to the introduction destination system200, and the introduction target system 300 recognizes that it has been registered as a user to the buddy list of the introduction destination system 200.

In the configuration shown in FIG. 1, the respective terminals are directly connected to each other. However, in actual operation, communications are conducted by obtaining an address of a system to be a communication partner on a network, based on identifier information. In Embodiment 1, it is assumed that communications are conducted via an information exchange server.

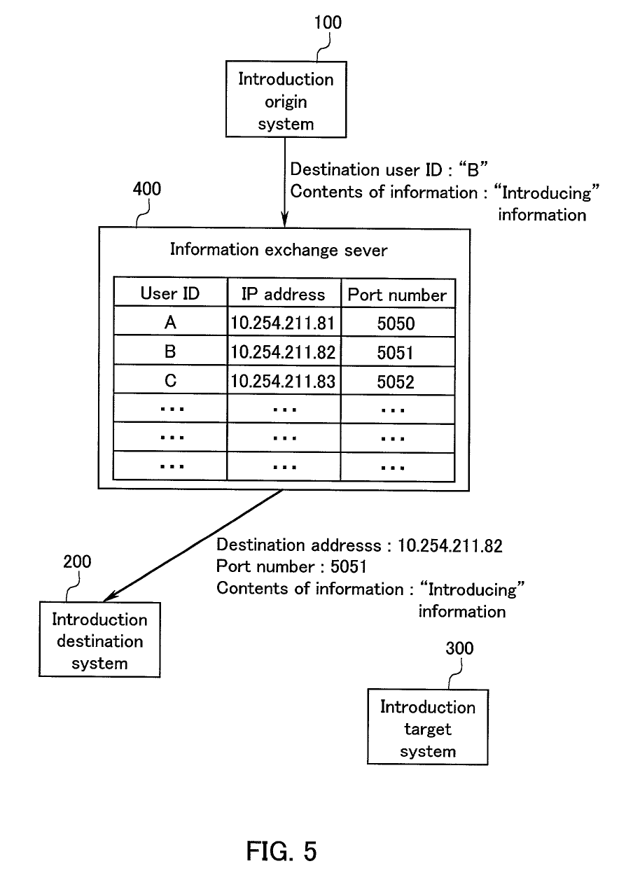

FIG. 5 shows an exemplary configuration of an exchange server 400. The exchange server 400 manages an identifier of each user system, and its position (e.g., an IP address and a port number) on the network. When information in which an identifier of a user system to be a destination is written in a particular part (e.g., a header part of leading 20 bytes) is sent to the exchange server 400, the contents of information are transferred to the introduction destination system according to the IP address and the port number registered as information on a destination. It is assumed that the position of the exchange server 400 on the network is managed by a name, for example, based on the DNS, and each user system is uniquely determined.

If the exchange server 400 is used as described above, information can be transferred among the respective user systems. The description of transfer of information is omitted here.

Next, a processing flow of the introduction system of Embodiment 1 according to the present invention will be described in detail by illustrating specific examples.

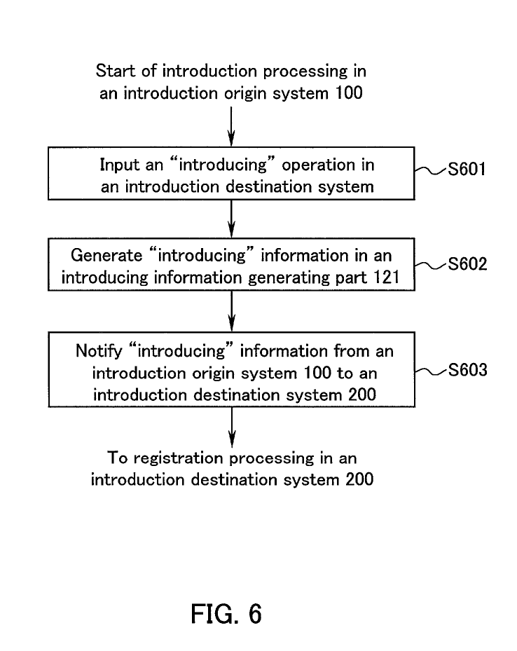

The processing flow of the introduction system is shown by flow charts in FIGS. 6 to 8.

(1) “Introducing” Processing in the Introduction Origin System 100 (FIG. 6)

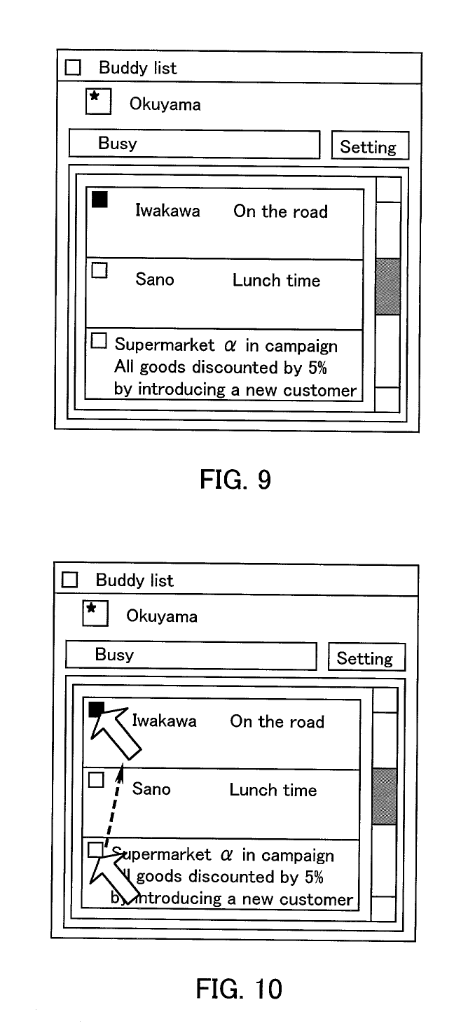

The user A of the introduction origin system 100 inputs an “introducing” operation (Operation 601). For example, although not shown in FIG. 1, the buddy list managing part 110 includes a buddy list display function, and the buddy list is displayed on a display screen as shown in FIG. 9. In this example, “Iwakawa”, “Sano”, and “Supermarket α” are registered as users to the buddy list. In the following description, “Okuyama” who is a user of the introduction origin system 100 introduces the user “Supermarket α” on the buddy list to the user “Iwakawa”. More specifically, in this case, the user of the introduction origin system 100 is “Okuyama”, the user of the introduction destination system 200 is “Iwakawa”, and the use entity of the introduction target system 300 is “Supermarket α”.

In the above example, it is assumed that a user can conduct an “introducing” operation by using a user interface on the buddy list with respect to the introducing part 120. For example, the user conducts an “introducing” operation as shown in FIG. 10, using the buddy list display screen shown in FIG. 9. More specifically, the user “Okuyama” of the introduction origin system 100 drags an icon of “Supermarket α” on the buddy list and drops it on an icon of “Iwakawa” on the buddy list. By providing such a user interface, an “introducing” operation becomes simple, and the effect of promoting an “introducing” action can be expected.

Next, “introducing” information is generated by the “introducing” information generating part 121 based on the “introducing” operation (Operation 602). The introducing part 120 of the introduction origin system 100 always monitors the operation with respect to the buddy list. When the above-mentioned “introducing” operation is conducted, the introducing part 120 detects the operation and generates the “introducing” information shown in FIG. 2.

As identifier information of the introduction origin system 100, i.e., identifier information of the user “Okuyama”, “A” is set; as identifier information of the introduction destination system 200, i.e., identifier information of the user “Iwakawa”, “B” is set; and as identifier information of the introduction target system 300, i.e., identifier information of the user “Supermarket α”, “C” is set.

Then, the introduction origin system 100 that is the user system of “Okuyama” notifies the introduction destination system 200 that is the user system of “Iwakawa” of “introducing” information through the “introducing” information notifying part 122 (Operation 603).

After notification processing (Operation 603) of the “introducing” information in the introduction origin system 100, registration processing starts in the introduction destination system 200.

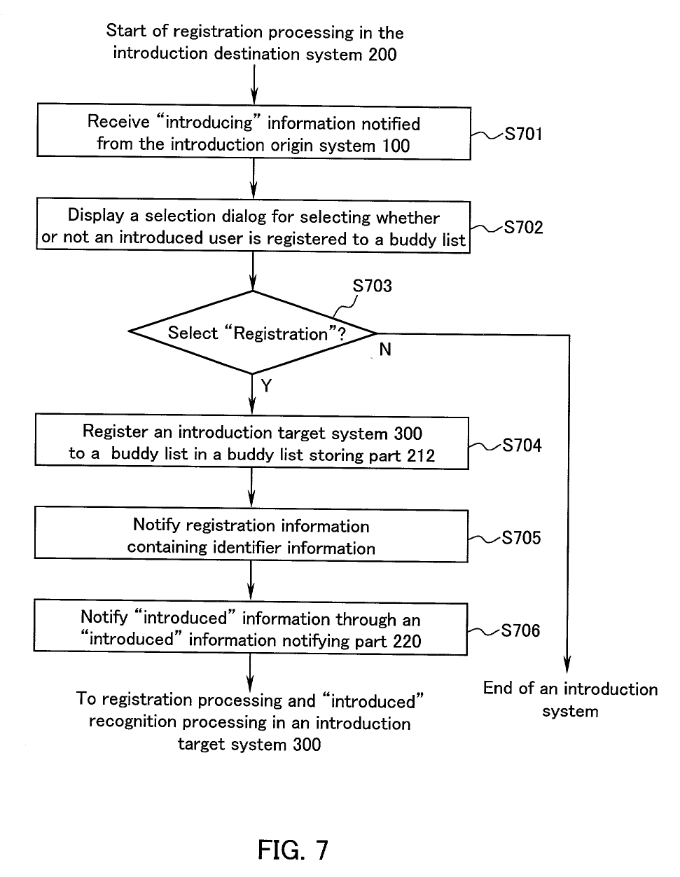

(2) Registration Processing in the Introduction Destination System 200 (FIG. 7)

The introduction destination system 200 is notified of the “introducing” information from the introduction origin system 100 (Operation 603), and starts registration processing.

The buddy list managing part 210 of the introduction destination system 200 that is the user system of “Iwakawa” receives the “introducing” information notified from the introduction origin system 100, and passes it to the buddy list registering part 211 (Operation 701).

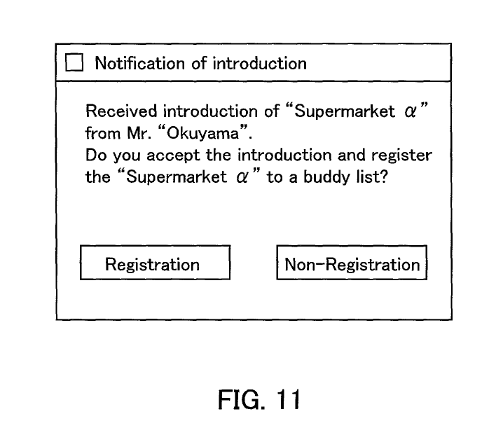

Next, the introduction destination system 200 of “Iwakawa” displays in the buddy list registering part 211 that the user “Supermarket α” is introduced by the user “Okuyama” as shown in FIG. 11, and a selection dialog for selecting whether or not the user “Supermarket α” is registered in the buddy list (Operation 702).

When the user “Iwakawa” of the introduction destination system 200 selects “Registration” (Operation 703: Y), the buddy list registering part 211 registers the user “Supermarket α” that is the introduction target system 300 on the buddy list in the buddy list storing part 212 (Operation 704).

In the case where the user “Supermarket α” that is the introduction target system 300 is registered to the buddy list, the introduction destination system 200 sends registration information containing the identifier “B” to the user “Supermarket α” that is the introduction target system 300 through the registration information notifying part 213 (Operation 705). The registration information is received by the registration information receiving part 311 in the introduction target system 300.

The “introduced” information notifying part 220 generates “introduced” information as shown in FIG. 3, and notifies the user “Supermarket α” that is the introduction target system 300 of the “introduced” information (Operation 706).

After the notification processing of the “introduced” information in the introduction destination system 200 (Operation 706), registration recognition processing is started in the introduction target system 300. Herein, although the order of Operations 705 and 706 are as described above for convenience, it may be changed, or these operations may be conducted in parallel.

When the user “Iwakawa” of the introduction destination system 200 selects “Non-Registration” (Operation 703: N), Operations 704 to 706 are not conducted, and registration processing in the introduction destination system 200 is completed. Furthermore, the registration recognition processing is not started in the introduction target system 300, and the processing of the introduction system is completed.

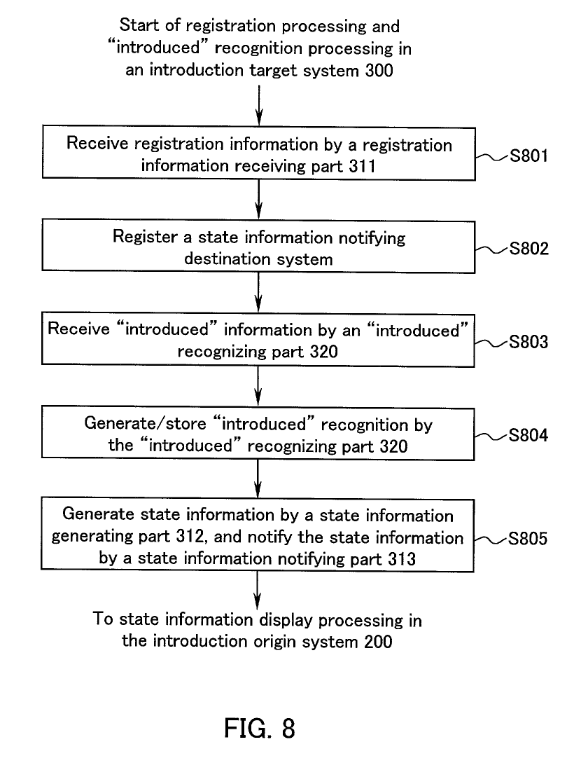

(3) Registration Processing in the Introduction Target System 300 (FIG. 8)

The user “Supermarket α” that is the introduction target system 300 is notified of the “introduced” information of the introduction destination system 200 (Operation 706), and starts the following registration processing.

The buddy list control part 310 of the introduction target system 300 receives registration information notified from the registration information notifying part 213 of the introduction destination system 200 through the registration information receiving part 311 (Operation 801), extracts the identifier “B” of the introduction destination system 200 from the registration information, and registers the introduction destination system as a system to be notified of state information (Operation 802).

The “introduced” recognizing part 320 receives the “introduced” information notified from the “introduced” information notifying part 220 of the introduction destination system 200 (Operation 803). The “introduced” recognizing part 320 generates “introduced” recognition information in the form of a table in which the identifier information of the introduction origin system 100 contained in the received “introduced” information is associated with the identifier information of the introduction destination system 200, as shown in FIG. 4, and stores the generated “introduced” recognition information (Operation 804).

After the above-mentioned registration processing (Operations 801 to 804), the buddy list control part 310 of the introduction target system 300 notifies the introduction destination system 200 of state information generated by the state information generating part 312 at a predetermined timing through the state information notifying part 313, based on the identifier of the registered introduction destination system 200 (Operation 805).

(4) State Display Processing of the Introduction Target System 300 in the Introduction Destination System 200, and Communication Support Processing from the Introduction Destination System 200 to the Introduction Target System 300

Upon being notified of the state information from the introduction destination system 200, the state information display part 215 of the introduction destination system 200 displays the state of the introduction target system 300 based on the state information.

The processing flow of the introduction system of Embodiment 1 mainly based on the “introducing” processing and the “introduced” recognition processing is as described above.

In the case where, in the introduction destination system 200 that is notified of the state information and displays it, a user desires to communicate with the introduction target system 300, it is preferable that the user can receive support for formation of a communication path to the introduction target system 300 by selecting a user entry of the introduction target system 300 displayed on the buddy list.

Due to the above-mentioned series of operations, the user “Supermarket α” of the introduction target system 300 refers to the “introduced” recognition information, thereby recognizing that the user “Okuyama” of the introduction origin system 100 has introduced the “Supermarket α” to the user “Iwakawa” of the introduction destination system 200, and the user entry information of the “Supermarket α” has been registered in the buddy list system of the user system “Iwakawa”.

### EMBODIMENT 2

An introduction system of Embodiment 2 according to the present invention is obtained by modifying the introduction system of Embodiment 1, and is provided with a function of confirming whether or not an “introducing” action has been conducted. As a method for confirming an introduction relationship representing who is an introducer and who is an introduced person, various methods can be considered. Herein, the simplest example will be shown. More specifically, the “introducing” information representing the relationship between an introduction origin system and an introduction destination system obtained from the introduction origin system is compared with the “introduced” information representing the relationship between the introduction origin system and the introduction destination system obtained from the introduction destination system, and it is determined if there is matching therebetween, whereby the introduction relationship is confirmed.

The introduction system of Embodiment 2 according to the present invention conducts the “introducing” processing in the introduction origin system, the registration processing in the introduction destination system, and the registration processing and the “introduced” recognition processing in the introduction target system, in the same way as in Embodiment 1. In addition to these, the introduction system of Embodiment 2 conducts “introducing” information notification processing in the introduction origin system with respect to the introduction target system and “introducing” recognition processing and introduction confirmation processing in the introduction target system. In the same way as in Embodiment 1, introduction may be conducted on the basis of service provided by the introduction target system.

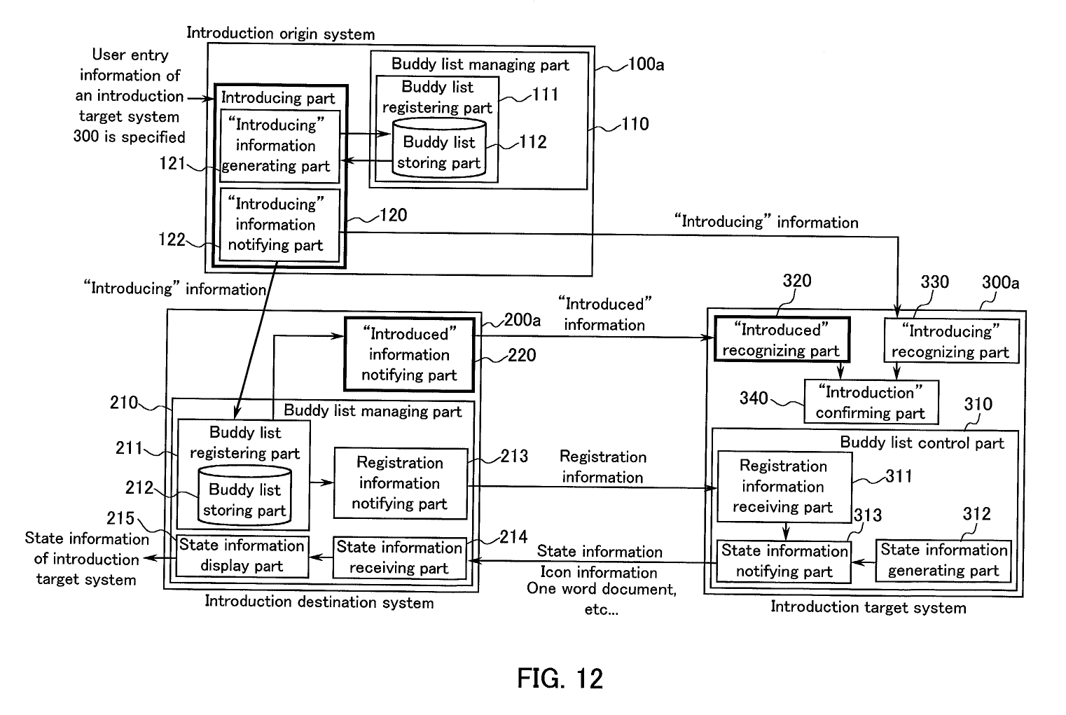

FIG. 12 shows a schematic configuration of the introduction system of Embodiment 2 according to the present invention.

Reference numeral 100a denotes an introduction origin system, 200a denotes an introduction destination system, and 300a denotes an introduction target system. In the same way as in Embodiment

1, the identifier of the introduction origin system 100 is “A”, the identifier of the introduction destination system 200 is “B”, and the identifier of the introduction target system 300 is “C”.

The introduction origin system 100a has the same configuration as that of the introduction origin system 100 in FIG. 1. However, in Embodiment 2, the “introducing” information notifying part 122 notifies an “introducing” recognizing part 330 of the introduction target system 300a of “introducing” information as well as the buddy list managing part 210 of the introduction destination system 200a of “introducing” information. Herein, the “introducing” information may be, for example, the same as that in Embodiment 1 shown in FIG. 2.

Next, the introduction destination system 200a may have the same configuration as that of the introduction destination system 200 in Embodiment 1 shown in FIG. 1.

Compared with the configuration of the introduction target system 300 of Embodiment 1, the introduction target system 300a further includes the “introducing” recognizing part 330 and an “introduction” confirming part 340.

The “introducing” recognizing part 330 receives “introducing” information notified from the “introducing” information notifying part 122 of the introduction origin system 100a, and recognizes an “introducing” action in the introduction origin system 100a based on the “introducing” information.

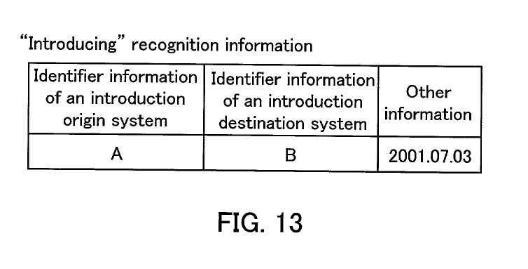

The “introducing” recognizing part 330 receives “introducing” information notified from the “introducing” information notifying part 122 of the introduction origin system 100a, and generates “introducing” recognition information from the received “introducing” information. The “introducing” recognition information to be generated is, for example, as shown in FIG. 13. This example includes three items: identifier information of an introduction origin system, identifier information of an introduction destination system, and other information (herein, introduction date and time). In this example, the respective items are provided with item values “A”, “B”, and “2001.07.03”. The “introducing” recognizing part 330 stores the generated “introducing” recognition information.

The “introduction” confirming part 340 compares the contents of a registration act in the introduction destination system 200a shown by the “introduced” recognition information recognized by the “introduced” recognizing part 320 with the contents of an “introducing” action in the introduction origin system 100a shown by the “introducing” recognition information recognized by the “introducing” recognizing part 330, thereby confirming matching therebetween. More specifically, in the case where the contents of the registration act are matched with those of the “introducing” action, the “introducing” action between the introduction origin system 100a and the introduction destination system 200a, and the registration act with respect to the buddy list conducted by accepting introduction are confirmed. The “introduction” confirming part 340 stores the results of introduction confirmation.

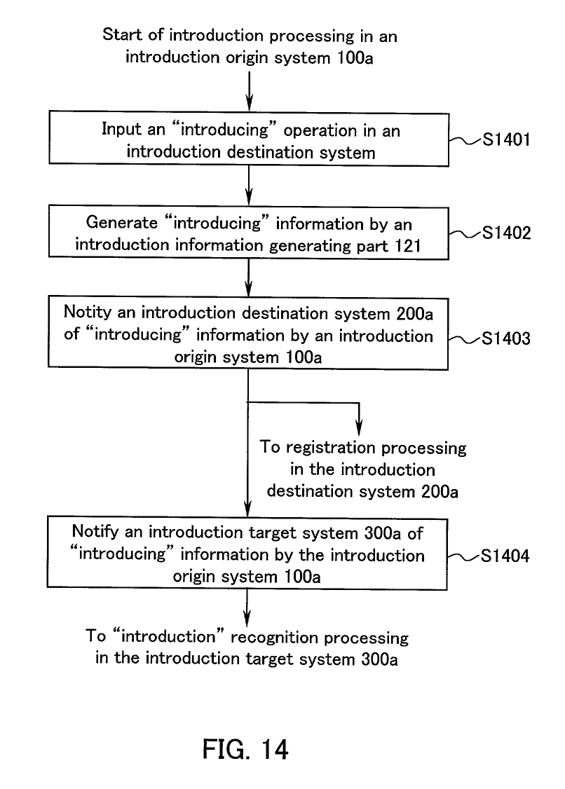

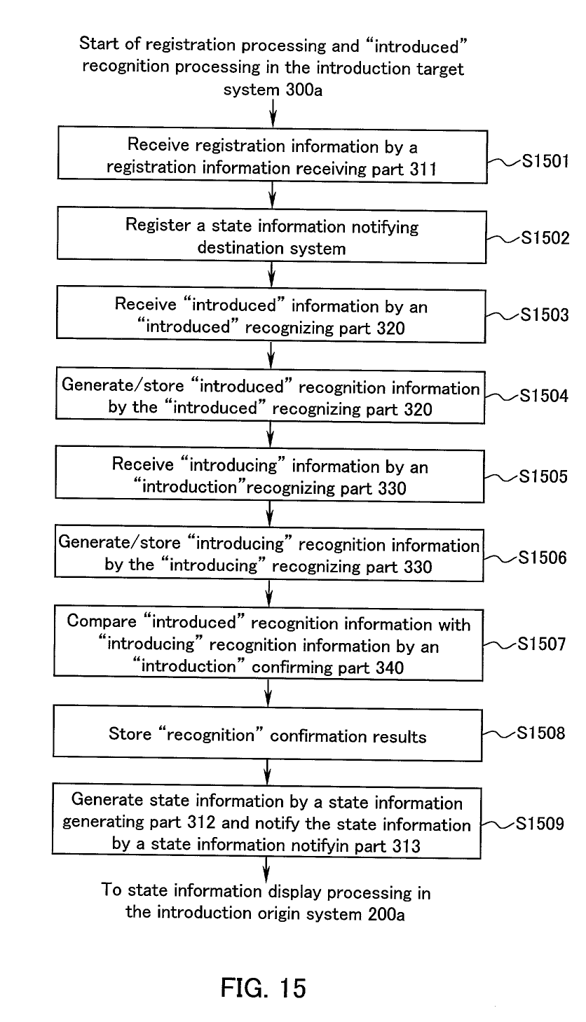

A processing flow of the introduction system of Embodiment 2 is shown by flow charts in FIGS. 14 and 15. In this example, a user of the introduction origin system 100a is “Okuyama”, a user of the introduction destination system 200a is “Iwakawa”, and a use entity of the introduction target system 300a is “Supermarket α”, and the user “Okuyama” of the introduction origin system 100 introduces the user “Supermarket α” on the buddy list to the user “Iwakawa”.

(1) “Introducing” Processing in the Introduction Origin System 100a (FIG. 14)

The processing operations from Operations 1401 to 1403 are the same as the input processing of an “introducing” operation by the user “Okuyama” of the introduction origin system 100a (Operation 601), the generation processing of “introducing” information (Operation 602), and the notification processing of the “introducing” information with respect to the introduction destination system 200a (Operation 603) shown in the flow chart of FIG. 6. The detailed description thereof will be omitted here.

After the notification processing of the “introducing” information in the introduction origin system 100a (Operation 1403), the introduction destination system 200a starts the registration processing upon being notified of the “introducing” information.

In the introduction system of Embodiment 2, after the notification processing of the “introducing” information with respect to the introduction destination system 200a (Operation 1403), the notification processing of “introducing” information with respect to the introduction target system 300a is conducted in the introduction origin system 100a. More specifically, the “introducing” information notifying part 122 notifies the introduction target system 300a of the “introducing” information (Operation 1404).

The introduction target system 300a starts the “introducing” recognition processing upon being notified of the “introducing” information in the introduction origin system 100a.

In the above-mentioned example, although the notification processing of the “introducing” information with respect to the introduction target system 300a (Operation 1404) is conducted after Operation 1403, the notification processing of the “introducing” information with respect to the introduction target system 300a may be conducted in parallel with the notification processing of the “introducing” information with respect to the introduction destination system 200a (Operation 1403).

(2) Registration Processing in the Introduction Destination System 200a

Upon being notified of the “introducing” information of the introduction origin system 100a (Operation 1403), the introduction destination system 200a starts registration processing.

The registration processing is the same as that (FIG. 7) in the introduction destination system 200 in Embodiment 1, and the description thereof will be omitted here.

(3) Registration Processing and “Introduced” Recognition Processing, “Introducing” Recognition Processing, Introduction Confirmation Processing in the Introduction Target System 300a (FIG. 15)

The introduction target system 300a is subjected to the registration information notification processing (Operation 705) and the “introduced” information notification processing (Operation 706) from the introduction destination system 200a, and starts registration processing and “introduced” recognition processing.

Furthermore, the introduction target system 300a is notified of “introducing” information (Operation 1404) from the introduction origin system 100a, and starts “introducing” recognition processing.

Furthermore, the introduction target system 300a receives the results of the registration recognition processing and the “introducing” recognition processing, and starts introduction confirmation processing.

The registration recognition processing is the same as that (FIG. 8) in the introduction target system 300 in Embodiment 1. Therefore, the detailed description thereof will be omitted here. Receiving processing of the registration information of the introduction destination system 200a (Operation 1501), registration processing of the state information notification destination system (Operation 1502), receiving processing of the “introduced” information (Operation 1503), and generation/storing processing of the “introduced” recognition information (Operation 1504) correspond to Operations 801 to 804 in FIG. 8. As a result of the registration recognition processing, the “introduced” recognizing part 320 stores the “introduced” recognition information shown in FIG. 4.

The “introducing” recognition processing is conducted in the following flow.

First, the “introducing” recognizing part 330 of the introduction target system 300a receives “introducing” information from the “introducing” information notifying part 122 of the introduction origin system 100a (Operation 1505).

The “introducing” recognizing part 330 generates and stores “introducing” recognition information as shown in FIG. 13, in the form of a table in which the identifier information of the introduction origin system 100a contained in the received “introducing” information is associated with the identifier information of the introduction destination system 200a (Operation 1506).

The introduction confirmation processing is conducted in the following flow.

First, the “introduction” confirming part 340 receives “introduced” recognition information obtained as the results of the “introduced” recognition processing in Operations 1503 and 1504 and “introducing” recognition information obtained as the results of the “introducing” recognition processing in Operations 1505 and 1506, and compares the contents of the “introduced” recognition information with those of the “introducing” recognition information (Operation 1507).

In the case where the contents of the “introduced” recognition information are matched with those of the “introducing” recognition information, the introduction confirmation processing succeeds. As a result, the “introduction” confirming part 340 can confirm the introduction relationship between the introduction origin system 100a and the introduction destination system 200a.

In the case where the contents of the “introduced” recognition information are not matched with those of the “introducing” recognition information, the introduction confirmation processing fails. As a result, the “introduction” confirming part 340 cannot confirm the introduction relationship between the introduction origin system 100a and the introduction destination system 200a.

The “introduction” confirming part 340 stores the introduction confirmation results thus obtained (Operation 1508).

After the above-mentioned processing (Operations 1501 to 1508), the buddy list control part 310 of the introduction target system 300a notifies the introduction destination system 200a of the state information generated by the state information generating part 312 through the state information notifying part 313 at a predetermined timing, based on the registered identifier of the introduction destination system 200a (Operation 1509).

The state display processing of the introduction target system 300a in the introduction destination system 200a and the communication support processing from the introduction destination system 200a to the introduction target system 300a are the same as those in Embodiment 1. Therefore, the description thereof will be omitted here.

The processing flow of the introduction system of Embodiment 2 mainly based on the “introducing” processing, the “introduced” recognition processing, the “introducing” recognition processing, and the introduction confirmation processing is as described above.

It is also possible to present the introduction confirmation results in the “introduction” confirming part 340 to a user. For example, a shopkeeper of the use entity “Supermarket α” of the introduction target system specifies the identifier information of the user “Okuyama” of the introduction origin and the identifier information of the user “Iwakawa” of the introduction destination, of which introduction relationship the shopkeeper desires to confirm, for example, by inputting a character string on a user interface of a terminal. The “introduction” confirming part 340 receives notification from the user interface, searches for the introduction confirmation results, and checks whether or not the user “Iwakawa” has been registered as the introduction destination of the user “Okuyama”. In the case where the introduction relationship is not confirmed, the “introduction” confirming part 340 displays that confirmation of the introduction relationship has failed. In the case where the introduction relationship is confirmed, the “introduction” confirming part 340 displays that confirmation of the introduction relationship has succeeded.

### EMBODIMENT 3

In an introduction system of Embodiment 3, it is assumed that a use entity of an introduction target system is a service provider providing some service and goods, and a user of an introduction origin system and a user of an introduction destination system are customers of the service provider. In this introduction system, a user is given an incentive to register user entry information of the service provider to a buddy list of the user, whereby configuration of an introduction relationship is promoted.

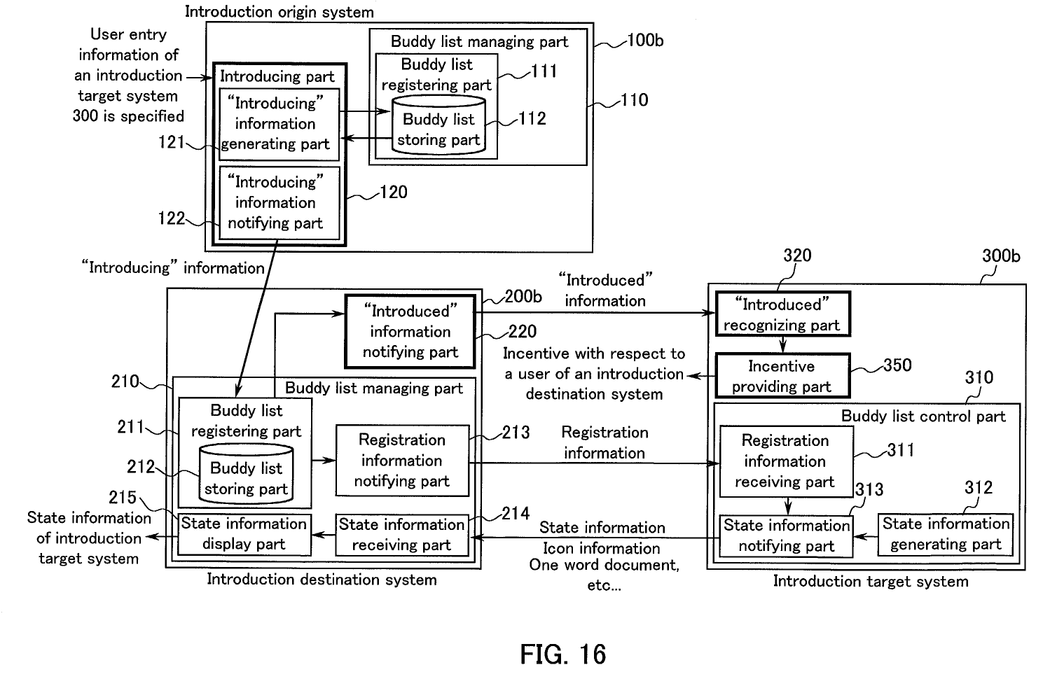

FIG. 16 is a view showing a schematic configuration of the introduction system of Embodiment 3 according to the present invention.

FIG. 16 shows a configuration in which an incentive providing part 350 is added to the configuration in Embodiment 1 shown in FIG. 1. Reference numeral 100b denotes an introduction origin system, 200b denotes an introduction destination system, and 300b denotes an introduction target system. The introduction target system 300b further includes the incentive providing part 350, compared with the configuration of the introduction target system 300 in FIG. 1.

The incentive providing part 350 determines and gives an incentive such as a reduction in a service use fee or the like with respect to either one or both of the introduction origin system 100b and the introduction destination system 200b, in the case where the “introducing” recognizing part 330 recognizes an “introducing” action and a registration action between the introduction origin system 100b and the introduction destination system 200b.

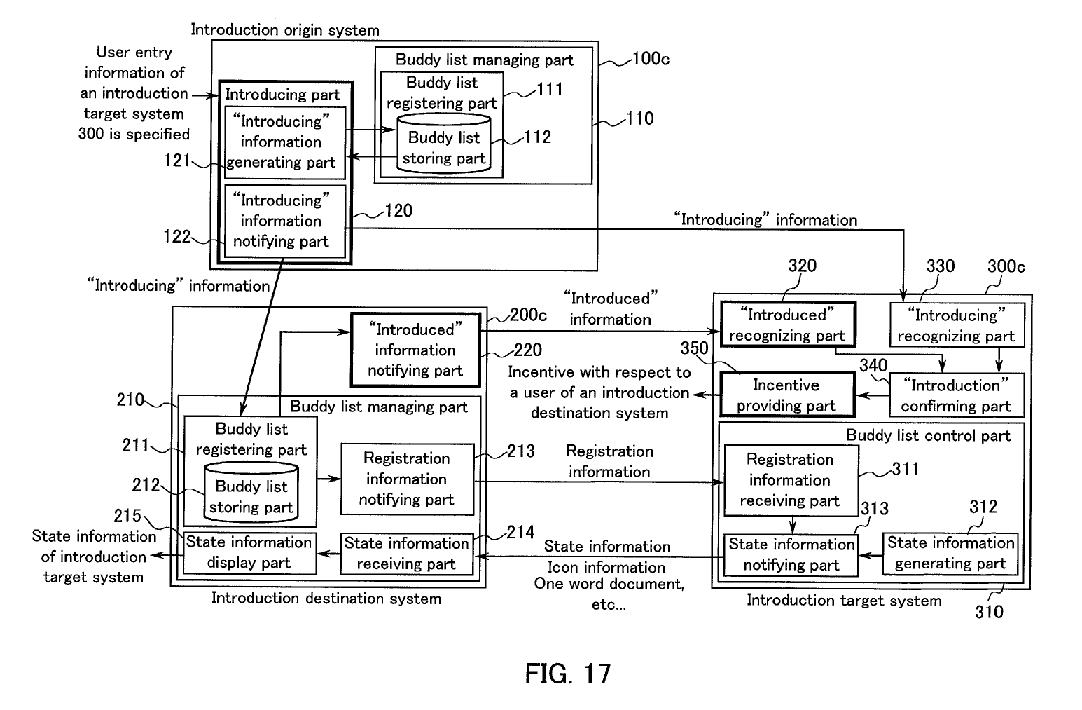

FIG. 17 shows another schematic configuration of the introduction system of Embodiment 3 according to the present invention. FIG. 17 shows a configuration in which an incentive providing part 350 is added to the configuration in Embodiment 2 shown in FIG. 12. Reference numeral 100c denotes an introduction origin system, 200c denotes an introduction destination system, and 300c denotes an introduction target system.

The incentive providing part 350 determines and gives an incentive such as a reduction in a service use fee or the like with respect to either one or both of the introduction origin system 100c and the introduction destination system 200c, in the case where the “introduction” confirming part 340 confirms an “introducing” action and a registration action between the introduction origin system 100c and the introduction destination system 200c.

For example, the following can be assumed as an incentive: all goods are discounted by 5% with respect to an introducing user (a user of the introduction origin system 100b or 100 c) or all goods are discounted by 5% with respect to an introduced user (a user of the introduction destination system 200b or 200c). By giving such an incentive, a service user can be motivated to introduce a new user.

The introduction system of the present invention can also present the contents of an incentive given based on the past “introducing” action and registration action or the contents of an incentive to be provided based on the future “introducing” action and registration action with respect to the introduction origin system and the introduction destination system.

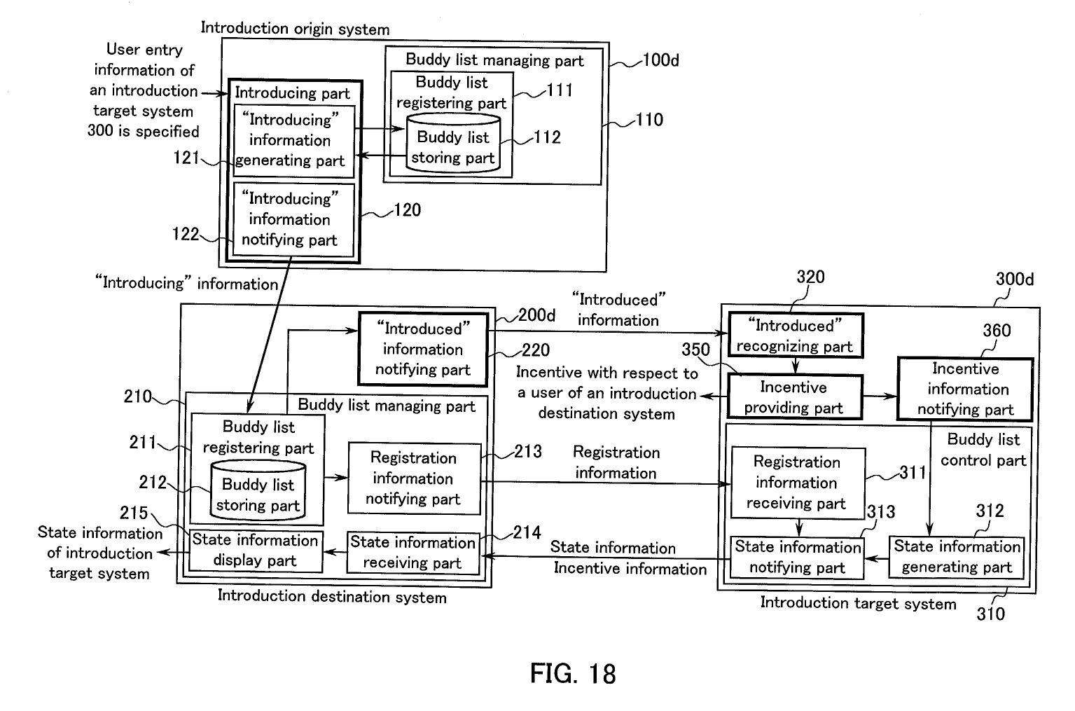

FIG. 18 shows a configuration in the case of presenting the contents of an incentive. An introduction target system 300d is provided with an incentive information notifying part 360.

The incentive information notifying part 360 generates display information regarding the contents of an incentive given based on the past “introducing” action and registration action or the contents of an incentive to be provided based on the future “introducing” action and registration action, and gives the display information to the state information notifying part 313.

The state information notifying part 313 notifies an introduction destination system 200d of display information regarding the contents of an incentive as one state information. In the introduction destination system 200d, information regarding the contents of an incentive is displayed as one state display of the introduction target system 300 through the state information display part 215. Thus, the incentive information is notified to the introduction destination system as a state display of a buddy list system. For example, “now, all goods are discounted by 5% for you”, “if you introduce a new customer, all goods are discounted by 7% for you”, and the like are displayed.

Incentive information may be displayed with respect to the introduction origin system 100d in the same way.

Incentive information may be sent when a user refers to presence information of service or when a service provider changes incentive information. In the former case, identifier information of a user attempting to refer to presence information is obtained, and incentive information corresponding to the user is obtained. These pieces of information are converted into character strings, and displayed on a user's buddy list screen as presence information.

### EMBODIMENT 4

In an introduction system of Embodiment 4, in the case where an introduction relationship between an introduction origin system and an introduction destination system is cancelled, recognition or confirmation of an “introducing” action and a registration action between the introduction origin system and the introduction destination system is invalidated to cancel an incentive. Herein, the case where the introduction relationship between the introduction origin system and the introduction destination system is cancelled corresponds to the case where entry information of an introduction target system is deleted from a buddy list in the introduction destination system and the case where the introduction destination system itself is not used any more (e.g., a terminal is abandoned). It should be noted that even in the case where these situations occur in the introduction origin system and a combination of these situations occurs, an embodiment similar to the present embodiment can be used.

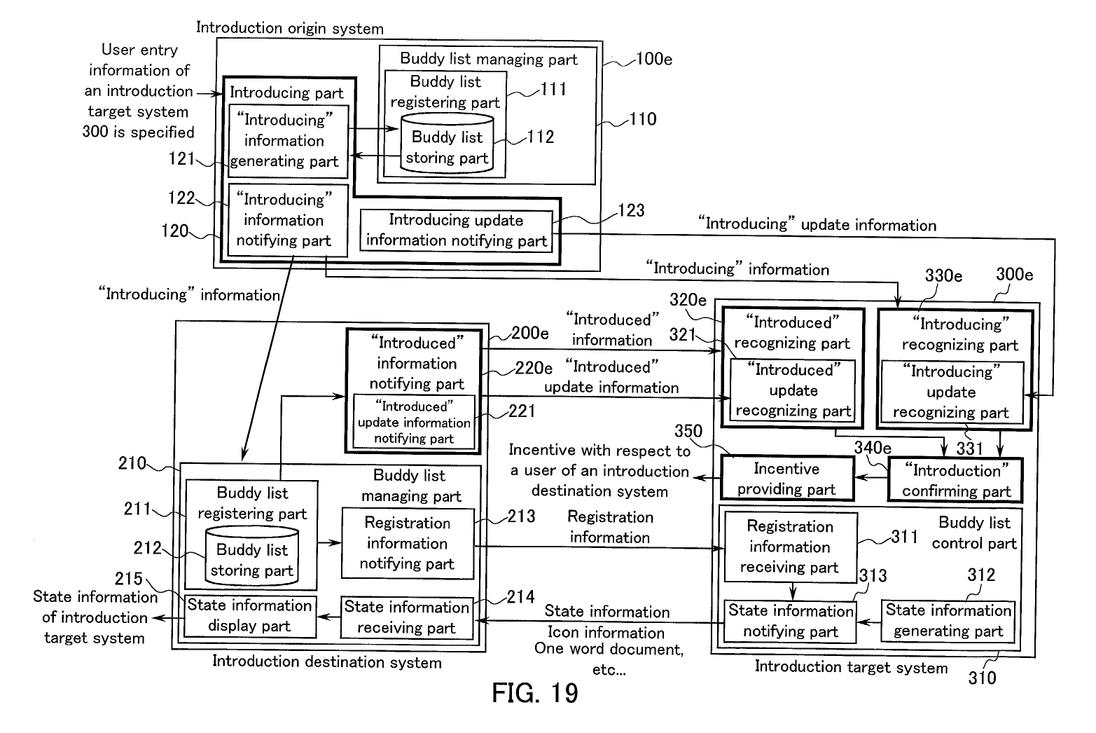

FIG. 19 shows a schematic configuration of an introduction system of Embodiment 4 according to the present invention.

An introduction origin system 100e includes an “introducing” update information notifying part 123 in an introducing part 120e. The “introducing” update information notifying part 123 generates “introducing” update information representing that the “introducing” action of the introduction origin system 100e is effective at a predetermined update timing, and notifies the introduction target system 300e of the “introducing” update information.

An introduction destination system 200e includes an “introduced” update information notifying part 221 in an “introduced” information notifying part 220e. The “introduced” update information notifying part 221 generates “introduced” update information representing that the registration action of the introduction destination system 200e having received introduction is effective, i.e., that user entry information of the introduction target system 300e is registered to a buddy list, and a state display and the like are conducted, at a predetermined update timing, and notifies the introduction target system 300e of the “introduced” update information.

In the introduction target system 300e, an “introduced” recognizing part 320e includes an “introduced” update recognizing part 321, and an “introducing” recognizing part 330e includes an “introducing” update recognizing part 331. The “introduced” update recognizing part 321 recognizes “introduced” update information notified from the “introduced” update information notifying part 221 of the introduction destination system 200e, and the “introducing” update recognizing part 331 recognizes “introducing” update information notified from the “introducing” update information notifying part 123 of the introduction origin system 100e. An “introduction” confirming part 340e confirms that the introduction relationship is effective.

The “introduction” confirming part 340e has an “introducing” update parameter and an “introduced” update parameter. The “introduction” confirming part 340e updates the “introducing” update parameter, upon being notified of the “introducing” update information from the introduction origin system 100e. Similarly, the “introduction” confirming part 340e updates the “introduced” update parameter, upon being notified of “introduced” update information from the introduction destination system 200e.

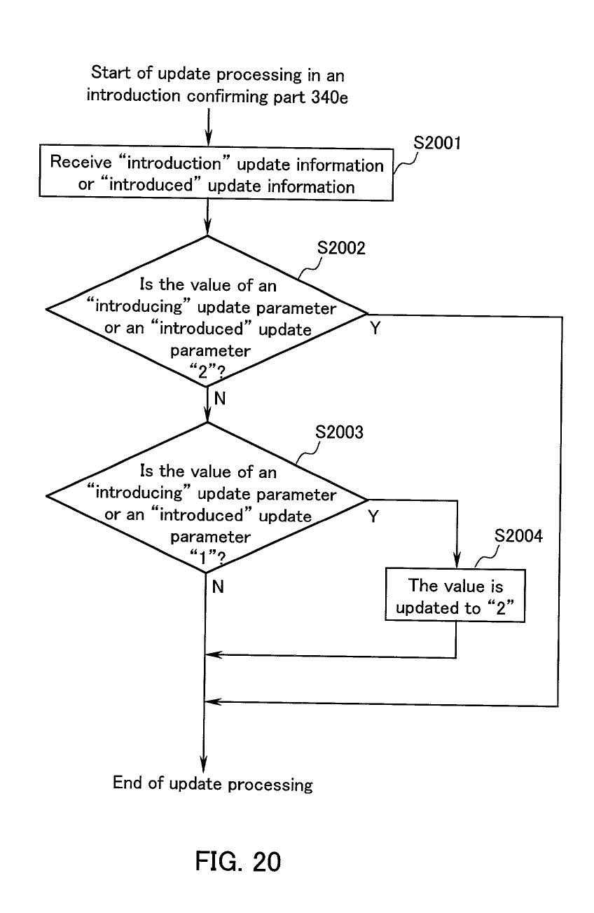

FIG. 20 shows an example of update processing of an introduction relationship based on the “introducing” update information and the “introduced” update information by the “introduction” confirming part 340e. In the following example, it is assumed that the base value of the “introducing” update parameter and the “introduced” update parameter is “2”, the value is updated to “2” by update processing, and the value is decreased by “1” every time the update confirmation processing described later is conducted. According to this configuration, if the “introducing” update parameter and the “introduced” update parameter are not updated by the time when the update confirmation processing is conducted twice continuously, the value of the update parameter becomes “0”.

First, the “introduction” confirming part 340e receives “introducing” update information or “introduced” update information (Operation 2001).

The “introduction” confirming part 340e checks the value of the “introducing” update parameter or the “introduced” update parameter. In this example, it is checked whether or not the value is “2” (Operation 2002), and if the value is “2” (Operation 2002: Y), it is determined that update has already been completed, and update processing is completed.

If the value of the “introducing” update parameter or the “introduced” update parameter is not “2” (Operation 2002: N), it is checked whether or not the value is “1” (Operation 2003). If the value is “1” (Operation 2003: Y), the value is updated to “2” (Operation 2004). After the value is updated, update processing is completed.

If the value of the “introducing” update parameter or the “introduced” update parameter is not “1” (Operation 2003: N), update processing is completed.

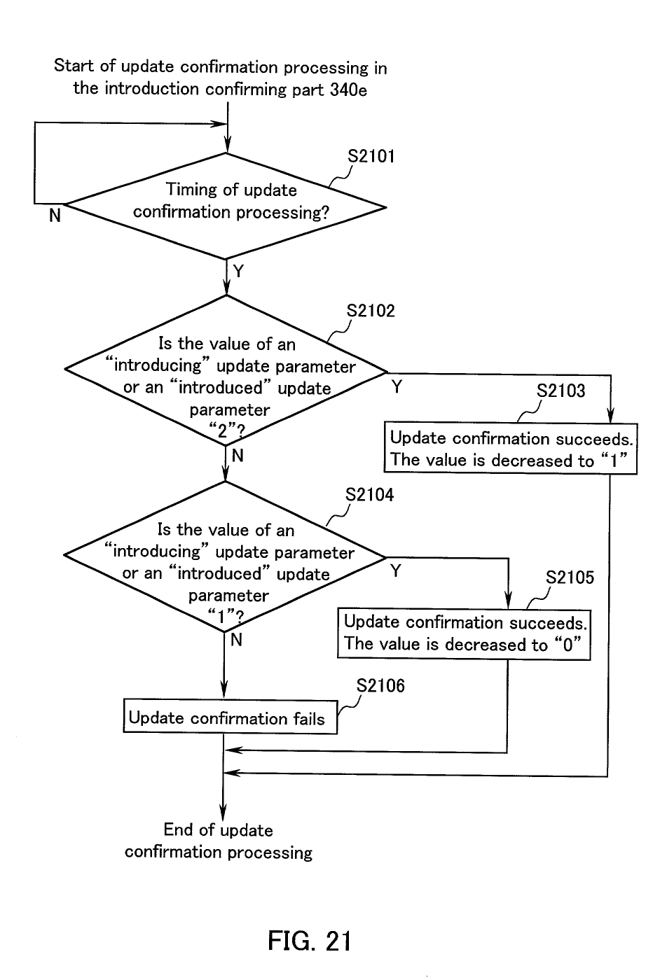

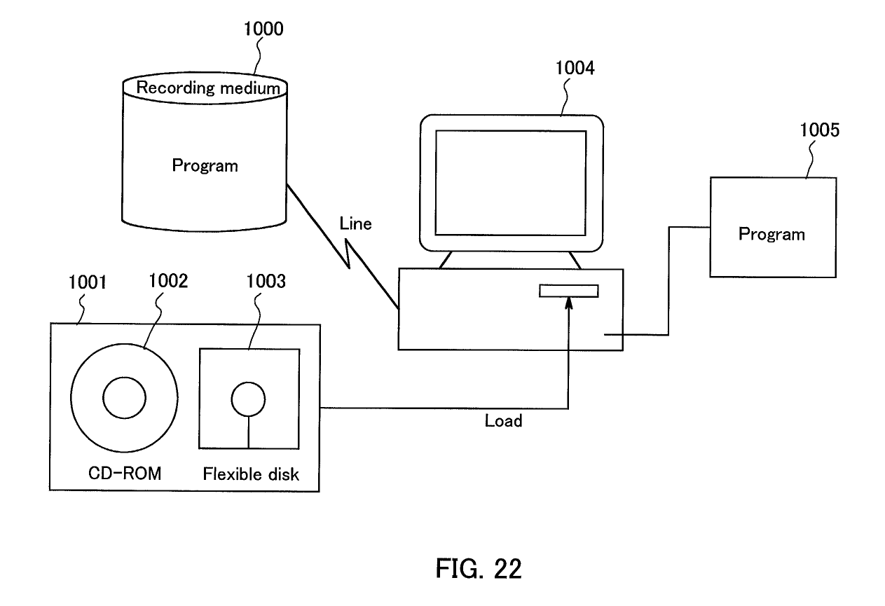

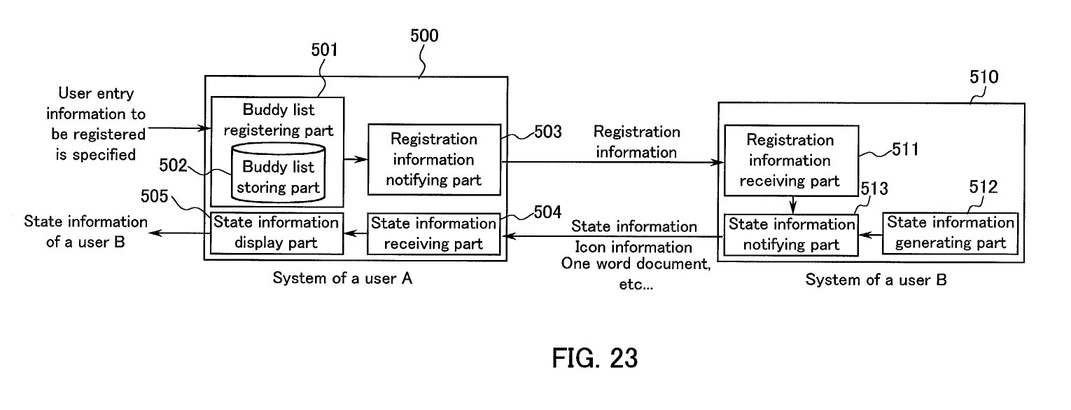

The update confirmation processing of the introduction relationship in FIG. 21 is conducted in the following procedure.

The “introduction” confirming part 340e checks the value of the “introducing” update parameter and the “introduced” update parameter at a predetermined timing (e.g., 12:00 a.m. once per day) (Operation 2101: Y). In the case where the value of the “introducing” update parameter or the “introduced” update parameter is “2” (Operation 2102: Y), it is determined that confirmation of the introduction relationship succeeds, and the parameter value is decreased by “1” (Operation 2103). In the case where the value of the “introducing” update parameter or the “introduced” update parameter is not “2” (Operation 2102: N) but “1” (Operation 2104: Y), it is determined that confirmation of the introduction relationship has succeeded, and the parameter value is decreased by “1” (Operation 2105). In the case where the “introducing” update parameter or the “introduced” update parameter is not “1” (Operation 2104: N) but “0”, it is determined that the update confirmation of the introduction relationship has failed (Operation 2106), and the update confirmation of the introduction relationship is not conducted.

The case where the confirmation of the introduction relationship has failed corresponds to the case where “introducing” update information or “introduced” update information cannot be notified or received from the introduction origin system 100e or the introduction destination system 200e, and while the “introducing” update parameter and the “introduced” update parameter are not updated to “2”, first update confirmation is conducted at a predetermined timing to decrease the value by “1”, and the second update confirmation is further conducted.

In the above-mentioned example, the base value of the “introducing” update parameter and the “introduced” update parameter is set at “2”, and when update confirmation fails twice and the value becomes “0”, it is determined that an introduction relationship is not effective. This is because notification of the “introducing” update information and confirmation of the “introduced” update information are conducted asynchronously. So, there is provided a margin to be considered in terms of an actual operation of a system. Thus, a margin is not inevitable matter. In the case where a margin is not required to be considered, the base value of the “introducing” update parameter and the “introduced” update parameter can be set at “1”. Alternatively, the base value of the “introducing” update parameter and the “introduced” update parameter can be set at “3” or higher with a larger margin. Furthermore, an update confirmation timing is set to be a predetermined timing (12:00 a.m. once per day). However, update confirmation processing of the introduction relationship may be conducted when the contents of incentive information is updated.

The introduction target system 300e can also conduct an initialization operation of incentive information on a predetermined period basis, and limit a period in which incentive can be provided to a predetermined period. When the incentive providing part 350 described in Embodiment 3 is used, the incentive providing part 350 continues to give an incentive at a predetermined timing in the case of being notified of update of the introduction relationship from the “introduction” confirming part 340e, and stops providing an incentive in the case of not being notified of update of the introduction relationship.

The present embodiment has been described mainly based on the case where a terminal of an introduction destination system is present. However, in the case where the terminal of the introduction destination system is abandoned, required “introduced” update information is not sent from the introduction destination system. Therefore, update confirmation cannot be obtained in the “introduction” confirming part.

### EMBODIMENT 5

The introduction system of the present invention can be configured by providing a program describing processing operations for realizing the above-mentioned configuration and installing the program onto a computer. The program containing processing operations for realizing the introduction system of the present invention can be provided by being recorded onto a recording medium 1000 in a recording apparatus on a network and a recording medium 1005 such as a hard disk and a RAM of a computer, as well as a portable recording medium 1001 such as a CD-ROM 1002 and a flexible disk 1003. Furthermore, the program can be downloaded through the network. In execution, the program is loaded onto a computer 1004.

According to the introduction system of the present invention, an “introducing” action from an introduction origin system to an introduction destination system and a registration action with respect to a buddy list are smoothly conducted, and an introduction target system can recognize that there is an registration action onto a buddy list.

Furthermore, according to the introduction system of the present invention, the introduction target system receives notification of “introducing” action from the introduction origin system, and compares the received notification of the “introducing” action with the contents of the notification of the registration action from an introduction destination system, thereby confirming the “introducing” action.

Furthermore, according to the introduction system of the present invention, an incentive can be given to users of an introduction origin system and an introduction destination system in which an “introducing” action and a registration action are recognized and confirmed, and registration onto a buddy list of the introduction target system can be promoted.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An introduction system for allowing an introduction origin system to introduce an introduction target system to an introduction destination system through an on-line network system,
the introduction origin system comprising an introducing part for notifying the introduction destination system of “introducing” information containing user entry information of the introduction target system,
the introduction destination system comprising a registering part for receiving the “introducing” information notified from the introducing part of the introduction origin system and registering user entry information of the introduction target system on a user list, and an “introduced” information notifying part for detecting registration of the user entry information of the introduction target system on the user list in the registering part and notifying the introduction target system of “introduced” information representing that a registration action based on introduction has been conducted, and
the introduction target system comprising an “introduced” recognizing part for receiving “introduced” information from the “introduced” information notifying part of the introduction destination system and recognizing a registration action to the user list in the introduction destination system.

2. An introduction system according to claim 1, wherein the user list is a buddy list,
a buddy list system is configured between the introduction destination system and the introduction target system, based on registration of a user entry of the introduction target system to the buddy list of the introduction destination system,
the introduction target system notifies the introduction destination system of state information representing a state of the introduction target system through a network, and
the introduction destination system obtains the state information of the introduction target system through the network and refers to it.

3. An introduction system according to claim 1, wherein the introducing part of the introduction origin system has a function of notifying the introduction target system that an “introducing” action has been conducted, and
the introduction target system further comprises an “introducing” recognizing part for receiving “introducing” information notified from the introducing part of the introduction origin system and recognizing the “introducing” action in the introduction origin system based on the “introducing” information, and an “introduction” confirming part for comparing contents recognized by the “introduced” recognizing part with contents recognized by the “introducing” recognizing part, and confirming an introduction relationship between the introduction origin system and the introduction destination system.

4. An introduction system according to claim 2, wherein the introducing part of the introduction origin system has a function of notifying the introduction target system that an “introducing” action has been conducted, and
the introduction target system further comprises an “introducing” recognizing part for receiving “introducing” information notified from the introducing part of the introduction origin system and recognizing the “introducing” action in the introduction origin system based on the “introducing” information, and an “introduction” confirming part for comparing contents recognized by the “introduced” recognizing part with contents recognized by the “introducing” recognizing part, and confirming an introduction relationship between the introduction origin system and the introduction destination system.

5. An introduction system according to claim 1, wherein the introduction target system is a service provider, and
the introduction target system includes an incentive providing part for giving an incentive to change conditions for providing service with respect to either one or both of the introduction origin system and the introduction destination system, in a case where the “introduced” recognizing part recognizes an introduction relationship between the introduction origin system and the introduction destination system.

6. An introduction system according to claim 2, wherein the introduction target system is a service provider, and
the introduction target system includes an incentive providing part for giving an incentive to change conditions for providing service with respect to either one or both of the introduction origin system and the introduction destination system, in a case where the “introduced” recognizing part recognizes an introduction relationship between the introduction origin system and the introduction destination system.

7. An introduction system according to claim 3, wherein the introduction target system is a service provider, and
the introduction target system includes an incentive providing part for giving an incentive to change conditions for providing service with respect to either one or both of the introduction origin system and the introduction destination system, in a case where the “introduced” recognizing part recognizes an introduction relationship between the introduction origin system and the introduction destination system.

8. An introduction system according to claim 3, wherein the introduction target system is a service provider, and
the introduction target system includes an incentive providing part for giving an incentive to change conditions for providing service with respect to either one or both of the introduction origin system and the introduction destination system, in a case where the “introduction” confirming part confirms an introduction relationship between the introduction origin system and the introduction destination system.

9. An introduction system according to claim 5, wherein the introduction target system includes an incentive notifying part for notifying the introduction origin system or the introduction destination system of contents of an incentive given by the incentive providing part based on a past “introducing” action and registration action or contents of an incentive to be provided by the incentive providing part based a future introduction relationship.

10. An introduction system according to claim 6, wherein the introduction target system includes an incentive notifying part for notifying the introduction origin system or the introduction destination system of contents of an incentive given by the incentive providing part based on a past “introducing” action and registration action or contents of an incentive to be provided by the incentive providing part based a future introduction relationship.

11. An introduction system according to claim 7, wherein the introduction target system includes an incentive notifying part for notifying the introduction origin system or the introduction destination system of contents of an incentive given by the incentive providing part based on a past “introducing” action and registration action or contents of an incentive to be provided by the incentive providing part based a future introduction relationship.

12. An introduction system according to claim 8, wherein the introduction target system includes an incentive notifying part for notifying the introduction origin system or the introduction destination system of contents of an incentive given by the incentive providing part based on a past “introducing” action and registration action or contents of an incentive to be provided by the incentive providing part based a future introduction relationship.

13. An introduction system according to claim 1, wherein in a registering part of the introduction destination system, in a case where the entry information of the introduction target system is deleted from the user list or the introduction destination system is not used by a user any more, recognition or confirmation of the introduction relationship between the introduction origin system and the introduction target system is cancelled.

14. An introduction system according to claim 2, wherein in a registering part of the introduction destination system, in a case where the entry information of the introduction target system is deleted from the user list or the introduction destination system is not used by a user any more, recognition or confirmation of the introduction relationship between the introduction origin system and the introduction target system is cancelled.

15. An introduction system according to claim 3, wherein in a registering part of the introduction destination system, in a case where the entry information of the introduction target system is deleted from the user list or the introduction destination system is not used by a user any more, recognition or confirmation of the introduction relationship between the introduction origin system and the introduction target system is cancelled.

16. An introduction system according to claim 5, wherein in a registering part of the introduction destination system, in a case where the entry information of the introduction target system is deleted from the user list or the introduction destination system is not used by a user any more, recognition or confirmation of the introduction relationship between the introduction origin system and the introduction target system is cancelled.

17. An introduction system according to claim 8, wherein in a registering part of the introduction destination system, in a case where the entry information of the introduction target system is deleted from the user list or the introduction destination system is not used by a user any more, recognition or confirmation of the introduction relationship between the introduction origin system and the introduction target system is cancelled.

18. A method for supporting introduction, comprising:
displaying a plurality of reference users stored so as to be associated with users on a display apparatus in accordance with a request from a user;
detecting that one of the plurality of displayed reference users is selected and virtually moved to a display region of another reference user, and sending “introducing” information for introducing the another reference user to the selected reference user; and
accumulating introduction relationship information containing the user, the selected reference user, and the another reference user.

19. A method for allowing an introduction origin system to introduce an introduction target system to an introduction destination system through an on-line network system,
wherein the introduction origin system notifies the introduction destination system of “introducing” information containing user entry information of the introduction target system,
the introduction destination system receives “introducing” information notified from the introduction origin system and registers user entry information of the introduction target system on a user list,
the introduction destination system detects registration of the user entry information of the introduction target system in a buddy list to the user list, and notifies the introduction target system of “introduced” information representing that the registration action has been conducted, and
the introduction target system receives “introduced” information notified from the introduction destination system, and recognizes the registration action to the user list in the introduction destination system, based on the “introduced” information.

20. A program comprising processing operations for configuring an introduction system for allowing an introduction origin system to introduce an introduction target system to an introduction destination system through an on-line network system,
a processing program of an introduction origin system including an “introducing” processing operation of notifying the introduction destination system of “introducing” information containing user entry information of the introduction target system,
the processing program of the introduction destination system including a registration processing operation of receiving “introducing” information notified in the “introducing” processing operations of the processing program of the introduction origin system and registering the user entry information of the introduction target system on a user list, and a registration action notification processing operation of detecting registration of the user entry information of the introduction target system to the user list in the registration processing operation, and notifying the introduction target system of “introduced” information representing that the registration action has been conducted, and
a processing program of the introduction target system including a registration recognition processing operation of receiving the “introduced” information notified in the registration action notification processing operation of the processing program of the introduction destination system, and recognizing the registration action to the user list in the introduction destination system based on the “introduced” information.
